(19) United States
(12) Patent Application Publication
(10) Pub. No.: US 2009/0319567 A1
(43) Pub. Date: Dec. 24, 2009

(54) SYSTEM AND METHOD OF DATA MANAGEMENT USING A STRUCTURE TO PROPAGATE CHANGES TO REFERENCED OBJECTS

(75) Inventors: Jeffrey Max FRAZER, Cupertino, CA (US); Stuart Brevard RUSSELL, Sunnyvale, CA (US); Michael John BRENNER, Santa Cruz, CA (US)

Correspondence Address: Apple Inc.;c/o Novak Druce + Quigg LLP, 1000 Louisiana Street, Fifty-Third Floor, Houston, TX, 77002, US

(73) Assignee: Apple Inc., Cupertino, CA (US)

(21) Appl. No.: 12/145,228

(22) Filed: Jun. 24, 2008

(51) Int. Cl. G06F 17/30

(52) U.S. Cl. 707/103 Y; 707/E17.009

(57) ABSTRACT

A system, method, and computer-readable medium for data management are disclosed, the method comprising changing original data in an original referenced object to create a changed referenced object having changed data, in response to the changing, performing the following for a referencing object that references the original referenced object, (i) determining whether to accept the changed data, and if the changed data is accepted, reflecting the changed data in the referencing object, (ii) if the referencing object does not accept the changed data, determining whether to create a new referenced object storing the original data, and if yes, (1) creating the new referenced object having the original data, wherein the referencing object references the new referenced object, (iii) and if no, (1) determining whether to copy the original data from the original referenced object into the referencing object, and if yes, (a) replacing the original reference with a copy of the original data, thereby breaking a relationship between the referencing object and the original referenced object, and if no, (b) breaking a relationship between the original referenced object and the referencing object by removing the original reference. In various aspects, steps (b)(i)-(b)(iii) are each are processed for each object of a plurality of referencing objects, are user initiated, and are managed by metadata associated with the referencing object.

### BACKGROUND OF THE INVENTION

1. Field of the Invention

The invention relates to data management, and more particularly to data management in which a structure is organized with at least one referencing object that may reference a referenced object such that changes to data in the referenced object can be propagated through each referencing object.

2. Introduction

New software products often include complex structures and present many different tools and opportunities for the user to use and interact with to accomplish the purpose of the software. For example, spreadsheet software and word-processing software provide the user the ability to create documents that are useful for particular purposes. Software development includes a testing phase in which the software is vigorously tested to insure that each possible interaction from a user produces the designed result. Testing software can be developed to walk through a series of steps to insure that the software works as designed. These series of steps are test cases. For example, in a word-processing application, the test software may open a new document, select a font, type in some text, print the document, and save the document under a certain name.

Some developers test software using thousands of different test cases. These test cases often refer to a large amount of commonly used data. In some instances, the inventors found that 90% of the test cases referred to the same data element or the same data points, but that it was difficult to relate or reuse some of the data. In some cases, the same operation can be achieved in a number of different ways. For example if 100 test cases include launching the application and then performing different steps, then the data associated with the launching step will be the same for each test. For example, there are multiple ways to print a document. One could perform a right click operation, press a control key while simultaneously pressing another key (CTRL+P), pull down a menu listing and select print, and so forth. Testing software may be written so that a separate test case for each different way of printing may be processed to ensure that the program accomplishes the desired goal. Typically the testing software or test case is written in a free-form text field that sets forth each step in the test case. In this example, each test case for how to print a document may refer to commonly used data or processes, such as the final step of committing to print the document or the step of associating the print command with the particular document to be printed. Each test case is written in this free-form text field, which renders it difficult or impossible to coordinate use of any commonly used data.

Accordingly, what is needed in the art is a restructuring and revision of how test cases are developed such that the value of commonly used data can be maximized, and data redundancy can be minimized and the simplicity and order in which software is tested can be improved.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

This invention disclosure describes a system, method, and computer-readable medium for determining distribution of change in a referenced object to a referencing object. The system determines whether to accept changes made to a referenced object to affect all referencing objects, or alternatively multiple options for declining the changes.

The method is illustrative of the invention and the principles associated with the method are applicable to the system and computer readable medium. A method of data management is disclosed in which a structure is organized with a referencing object that may reference a referenced object comprising simple data elements. The method includes changing original data in an original referenced object to create a changed referenced object having changed data. In response to the changing, the method includes performing the following for a referencing object that references the original referenced object.

First, the method includes determining whether to accept the changed data, and if the changed data is accepted, reflecting the changed data in the referencing object. If the referencing object does not accept the changed data, the method determines whether to create a new referenced object storing the original data. If yes, the method creates the new referenced object having the original data, wherein the referencing object references the new referenced object. If no, the method determines whether to copy the original data from the original referenced object into the referencing object. If yes, the method replaces the original reference with a copy of the original data, thereby breaking a relationship between the referencing object and the original referenced object. If no, the method breaks a relationship between the original referenced object and the referencing object by removing the original reference.

One application of the invention is a data structure that contains test cases for testing software. Software testing may involve automated execution of long series of commands within an application to test the application's stability, scalability, performance, compatibility, etc. If particular commands or combinations of commands cause a program to crash, software engineers will generally redesign aspects of the application's code until a program exists that is sufficiently stable for use. These test cases can be contained within a data structure. This structure can be particularly useful because certain commands are frequently reused. Reused elements can use referencing objects to refer to main referenced objects for reuse and reduction of the overall size of the data structure.

In another context the invention may apply to a data structure that contains user data. For example, available native values for referencing may contain first name data for a user. For example it may have a primary first name, first initial and preferred name. Other data objects, such as for example legal name may reference the primary name of the first name data element. Therefore, if a change is made to the main object first name data, the system may determine to distribute the change to all referencing objects that reference the main data object. Alternatively the system may decline to distribute the change to all referencing objects and choose between multiple options for declining the changes. This is not an exhaustive list. Any data structure that utilizes referenced data objects and a referencing data object may benefit from the disclosed system and method of data management for determining distribution of change in an original referenced object to a referencing object.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates a data structure including referenced and referencing data objects;

FIG. 3 illustrates an example decision tree;

FIG. 4A illustrates an example of test case references including native and referenced steps;

FIG. 4B illustrates an example of test case references including two native steps and one referenced step;

FIG. 4C illustrates an example of viewing the referenced step from the test case;

FIG. 4D illustrates a test case containing multiple references with a native step in between;

FIG. 4E illustrates a referencing object constructed from other referenced objects;

FIG. 4F illustrates a more complex referencing object constructed from other referenced objects;

FIG. 4G illustrates a sample window illustrating the manipulation of the complex referencing object of FIG. 4F; and

FIG. 5 illustrates example embodiment of a method for database management.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

In order to address the issues set forth above, a structure is used to simplify test case management and allow for data reuse. The present disclosure looks at this issue from an object oriented perspective and shifts from a free-form text field approach. For any given test case, a series of one or more steps is involved (i.e., open application, select document, perform a print command in a certain way, etc.). The following is a general description of the structure disclosed herein. Conceptually, each step in a test case can consist of a number. Each step can be in a certain order and also include various data elements and any other amplifying data such as metadata and so forth. Once the step is structured as a step number, the step or process itself, and then the other data, such as verification data, may be associated with an object. The data associated with the object can be normalized from a database perspective such that the objects can be viewed and used as building blocks with interrelationships. The objects or elements therein can be reused and scattered across different test cases.

One simple example of the structure discussed above is illustrative. Assume there are 10,000 test cases for a new software product and each test case begins with a step of launching the software. The first step uses the path of the executable file to start the software. If the path changes, the structure disclosed herein enables the user to make one change to the path for the executable and the change is propagated throughout the 10,000 other test cases. Other changes to data should not be simply propagated to each referring object. Therefore, an aspect of this disclosure is how to provide an object by object analysis where individual objects can include intelligence guiding how to determine whether to accept changed data and perform associated processes based on that determination.

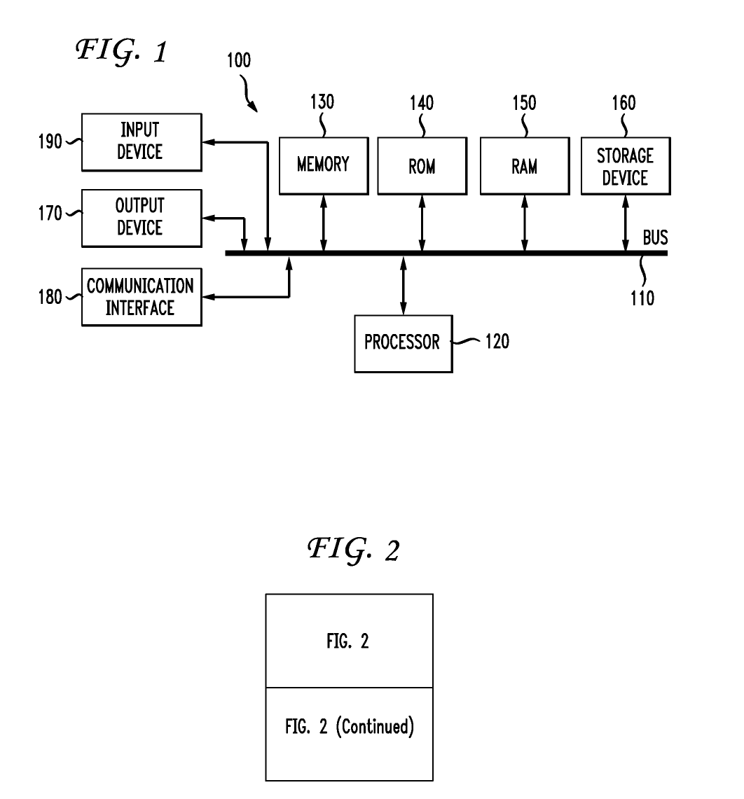

Prior to discussing the details more fully, the disclosure next presents the basic hardware components associated with the system embodiment of the invention. With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

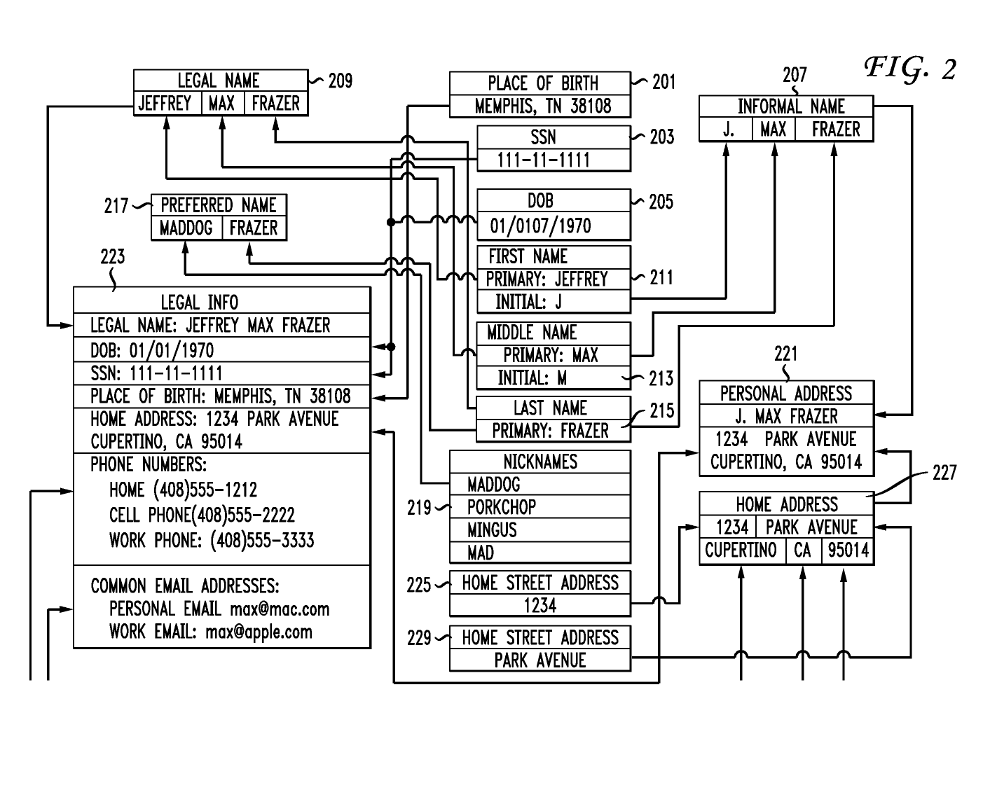

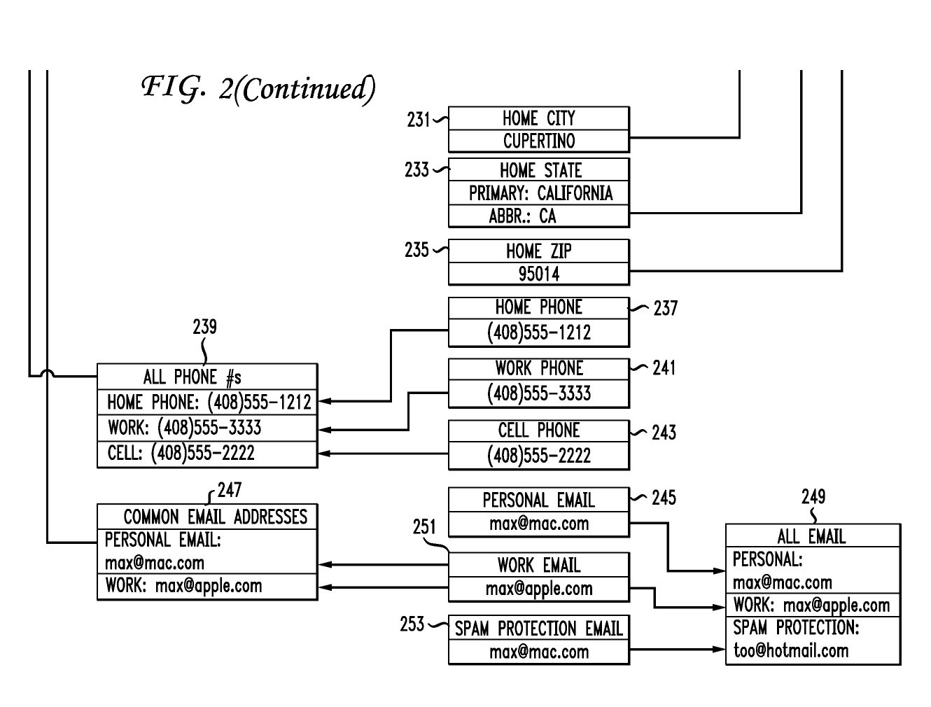

Having disclosed the basic components of the system embodiment, the disclosure now returns to the details of the object-based structure. The structure involves at least one referenced object and one or more referencing objects. FIG. 2 shows an example relationship between referenced objects and referencing objects. As noted above, the present disclosure enables a system, method, and computer-readable medium for determining distribution of change in a referenced object to a referencing object. Any data structure that is organized with a referencing object may reference a referenced object.

A data structure can contain a referencing object that may reference a referenced object comprising simple data elements. In the default case, changes made to a referenced object are automatically reflected in any referencing objects that refer to the referenced object. One aspect of this disclosure is to address a need for an option at the referencing object level to choose whether or not to accept the changes made to the referenced cells.

Software testing is one application of the principles described herein. In automated software testing, a testing program is written to verify the basic and advanced functionality, stability, performance, accuracy, responsiveness, etc. An automated testing program typically simulates one or more user interactions with the software. The principles described herein discuss native and referenced objects. An object in a software testing scenario includes a path to an executable, a line of text for input into a textbox, a series of clicks or keypresses, a delay, simulated speech, a mouse gesture, simulated network resource requests, or any other user input. In an ideal world, a battery of software tests includes every possible combination of user interactions to discover every possible bug. In even a simple program, the combination of user interactions quickly spirals out of control, leading many software testers to limit their scope to testing most common usage scenarios, boundary testing, etc. The principles described herein allow common portions in a battery of software tests to be stored in one place, thereby conserving storage space. Because references to common actions or information are updated and stored centrally, consistency in testing is improved.

Administration of tests is further simplified by change notification and change management when referenced data is altered. One example of how change management can be used is regression testing. Regression testing is performed as software is refined and improved to make sure that previously eliminated bugs are not accidentally reintroduced. As changes to the program are made and the testing suite evolves, a testing administrator accepts or rejects updates to references in order to preserve scenarios triggering previously eliminated bugs. Other data storage scenarios are also applicable.

FIG. 2 illustrates multiple examples of a referencing object that may reference a referenced object comprising simple data elements. For example, referencing object Legal Info 223 references referenced objects Legal Name 209, Date of Birth 205, SSN (Social Security Number) 203, Place of Birth 201, Home Address 227, Phone Numbers 229, and Common Email Addresses 247. Additionally, as shown in FIG. 2, referencing object Legal Name 209 references referenced objects First Name 211, Middle Name 213, and Last Name 215.

Referencing object Informal Name 207 references referenced objects First Name 211, Middle Name 213, and Last Name 215. The referencing objects may select which values they accept or display from the referenced object. For example, Legal Name 209 accepts the primary data from the First Name 211 referencing object, while Informal Name 207 accepts the initial data from First Name 211.

Referencing object Personal Address 221 references referenced objects Informal Name 207 and Home Address 227. Referencing object Preferred Name 217 references referenced objects Nicknames 219 and Last Name 215. Referencing object Home Address 227 references referenced objects Home Street Address 225, Home Street Name 229, Home City 231, Home State 233, and Home Zip 235.

In continuation of following the data structure of FIG. 2, referencing object Personal Address 221 references referenced objects Informal Name 207 and Home Address 227. Referencing object Preferred Name 217 references referenced objects Nicknames 219 and Last Name 215. Referencing object Home Address 227 references referenced objects Home Street Address 225, Home Street Name 229, Home City 231, Home State 233, and Home Zip 235.

Referencing object All Phone #s 239 references referenced objects Home Phone 237, Work Phone 241, and Cell Phone 243. Referencing object Common Email Addresses references referenced objects Personal Email 245 and Work Email 251. Referencing object All Emails 249 references referenced objects Personal Email 245, Work Email 251, and Spam Protection Email 253.

Referencing involves breaking down objects into unique, reusable elemental blocks, and making those blocks easily accessible from other objects. A referencing object is an object that contains one or more references to at least one other object. A referenced object, in turn, is any object that can be accessed via a reference from a referencing object. The original referenced object is the object that contains the unreferenced data upon which all subsequent references are based. A reference is the representation of the referenced object in the referencing object. Each referenced object may contain multiple data types and values in an ordered set. These data types and values may include (a) data native to the object and (b) references to one or more other objects (including pointers to data offered by external objects).

In a visual implementation, referenced data from external objects may be visually differentiated from native data. This can aid a user who is viewing a structured tree or other visual presentation of the data to easily understand whether the data in a particular object is native to that object or referenced data from a referenced object. In a preferred embodiment, the referenced data from external objects are treated as unmodifiable data in the referencing object. A referencing object may reference only selected attributes of a referenced object, as well as the entire object. Each referenced object may indicate what types of data it allows to be referenced. A user can select which attributes to reference if multiple ones are offered.

The proposed structure such as that shown in FIG. 2 enables the construction of new referencing objects from the ordered union of two or more previously defined objects. Each ordered union can then be referenced as a unique object by other high level objects. This referencing process can continue indefinitely, allowing the creation of highly complex ordered data sets, often resulting in a tree hierarchy. Other structures besides trees are possible since the branches may also reconnect to the structure in the chosen relationship between objects. References may be nested. References may also be circular, meaning the last reference may reference back to the first in a case where repetition is desired, but some mechanism or condition must be used to break out of the circular references. References are independent of the underlying object type, allowing special data requirements to be handled at a higher level, if necessary. References are application-independent, meaning they adapt their format to their destination. Single elemental blocks and references created from these elemental blocks may be used in both a single-user mode as well as concurrently with other users. Users may share references with other users in a permissions-based setting.

Concurrent usage of the data structure may be implemented by using a Relational Database Back-end. A Relational Database Back-end such as MySQL, PostgreSQL, Oracle, etc. may be utilized for this purpose. Users may specify how other users access their objects and references by, for example, Access Control Lists or Group Permissions. Also, in another embodiment the method and system for data management may use referencing within the context of a single user. In this embodiment, many data storage methods, for example CoreData would suffice.

A user can access the system and method for data management in a visual graphical embodiment. This allows users to quickly grab references from multiple sources to form a new object based on the union of these sources. In this visual embodiment, a user may select referenced and native granular data blocks in one object, and drag the selected items to reorder them relative to the remaining non-selected items. Furthermore, if a user selects and starts to drag a subset of items from one or more referenced data sets, the interface enforces referenced data set cohesion by automatically adding the rest of the items from each referenced data set to the dragged selection. This makes it impossible to move items out of referenced data sets or to reorder their items. Continuing in this visual embodiment, if a user tries to drag any items into the middle of a data set of a referenced object, the interface enforces referenced data set cohesion by refusing to accept the drop, and signaling the user that the drop will not work at the current mouse position. The interface forces the user to drop the items above or below the referenced data set object.

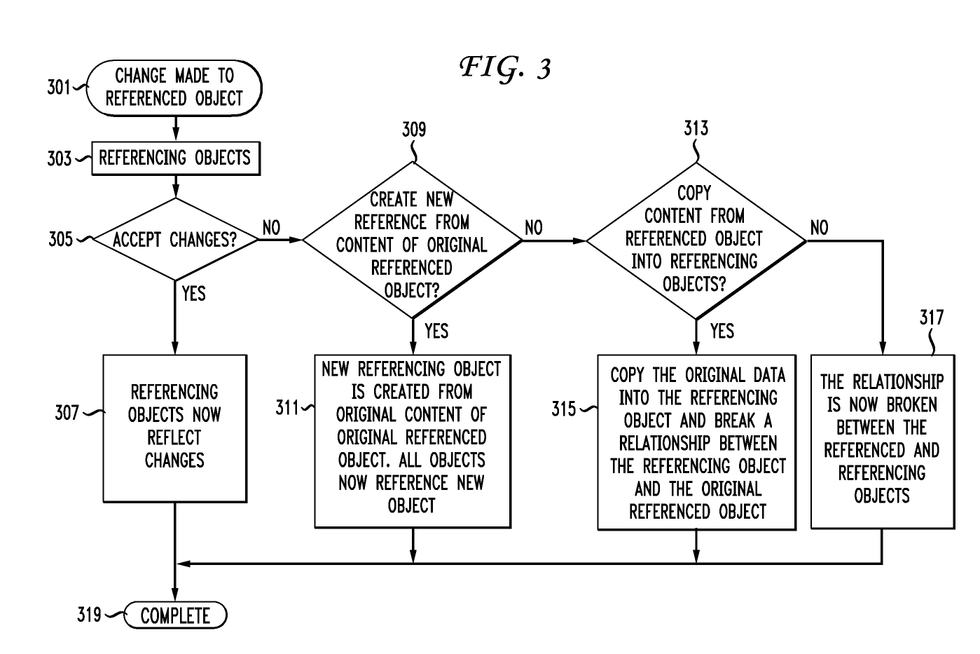

As discussed above, this invention disclosure describes a system and method for determining distribution of change in a referenced object to a referencing object. FIG. 3 illustrates an example decision structure for determining whether to accept changes made to a referenced object to affect all referencing objects, or alternatively multiple options for declining the changes.

A change is made to a referenced object 301 which may affect referencing objects 303. The method includes changing original data in an original referenced object to create a changed referenced object having changed data. Next, the method includes determining whether to accept the changed data 305, and if the changed data is accepted, reflecting the changed data in the referencing object 307.

If the referencing object does not accept the changed data, the method includes determining whether to create a new referenced object from content of the original referenced object 309. If yes, the method includes creating the new referenced object having the original data, wherein the referencing object references the new referenced object 311. If no, the method includes determining whether to copy the original data from the original referenced object into the referencing object 313. If yes, the method includes replacing the original reference with a copy of the original data, thereby breaking a relationship between the referencing object and the original referenced object 315. If no, the method includes breaking a relationship between the original referenced object and the referencing object 317 by removing the original reference. After following this flowchart, the decision structure for determining whether to accept changes made to a referenced object is complete 319.

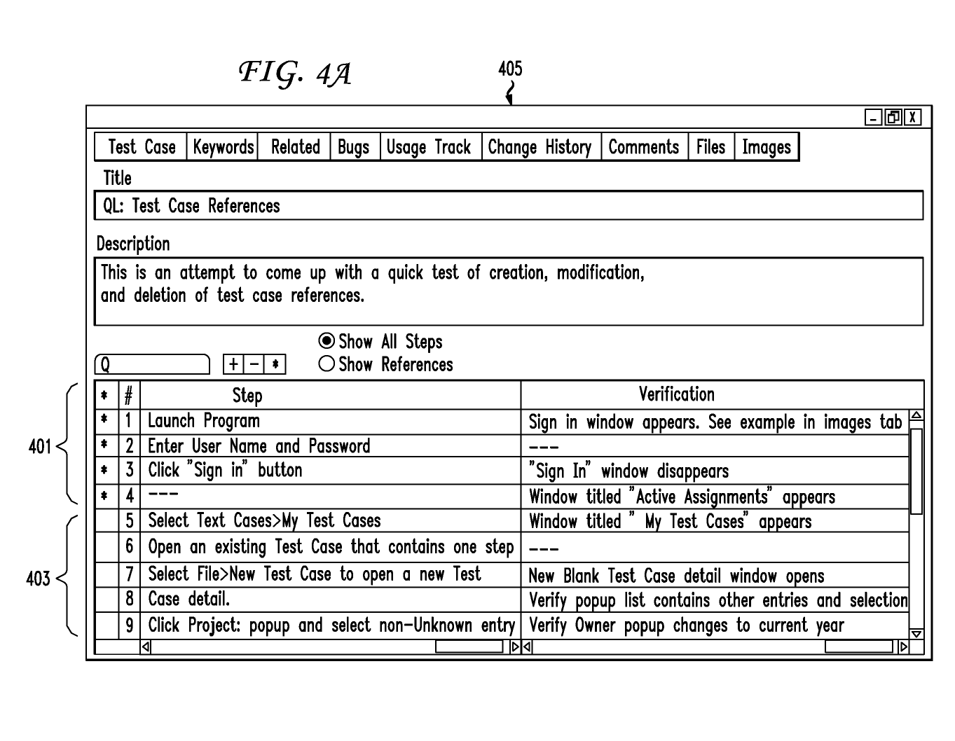

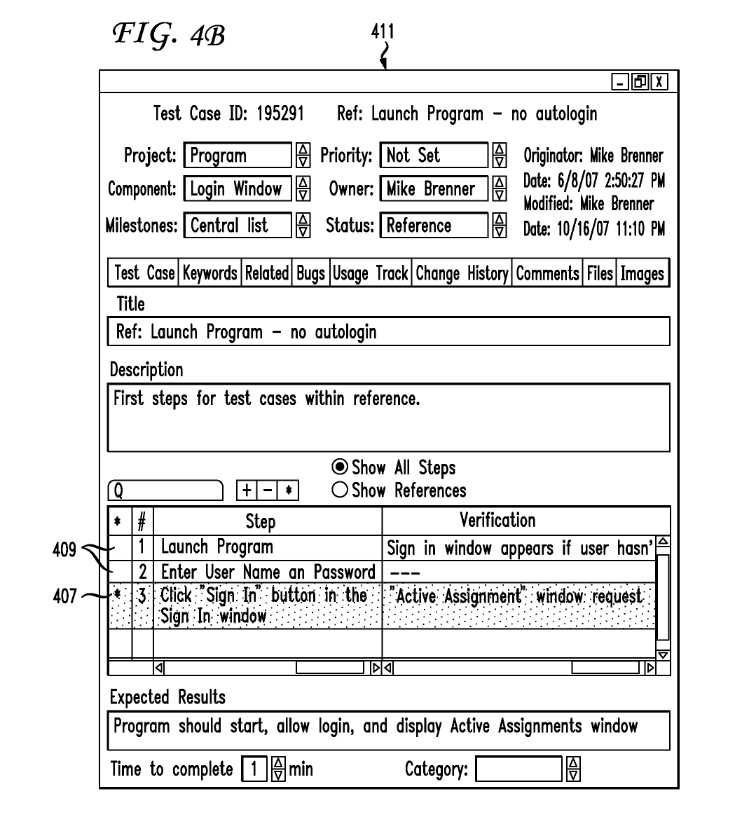

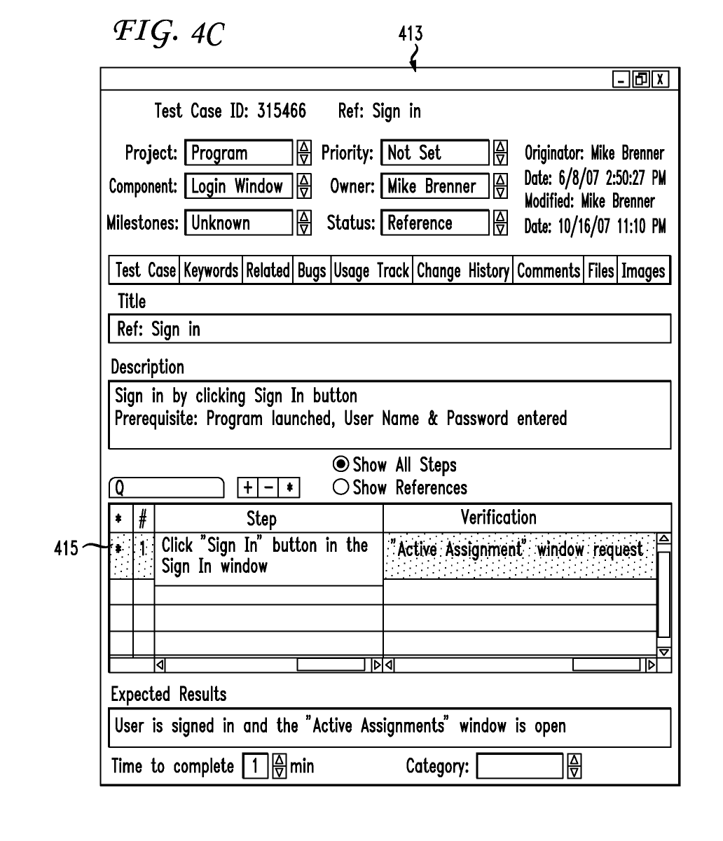

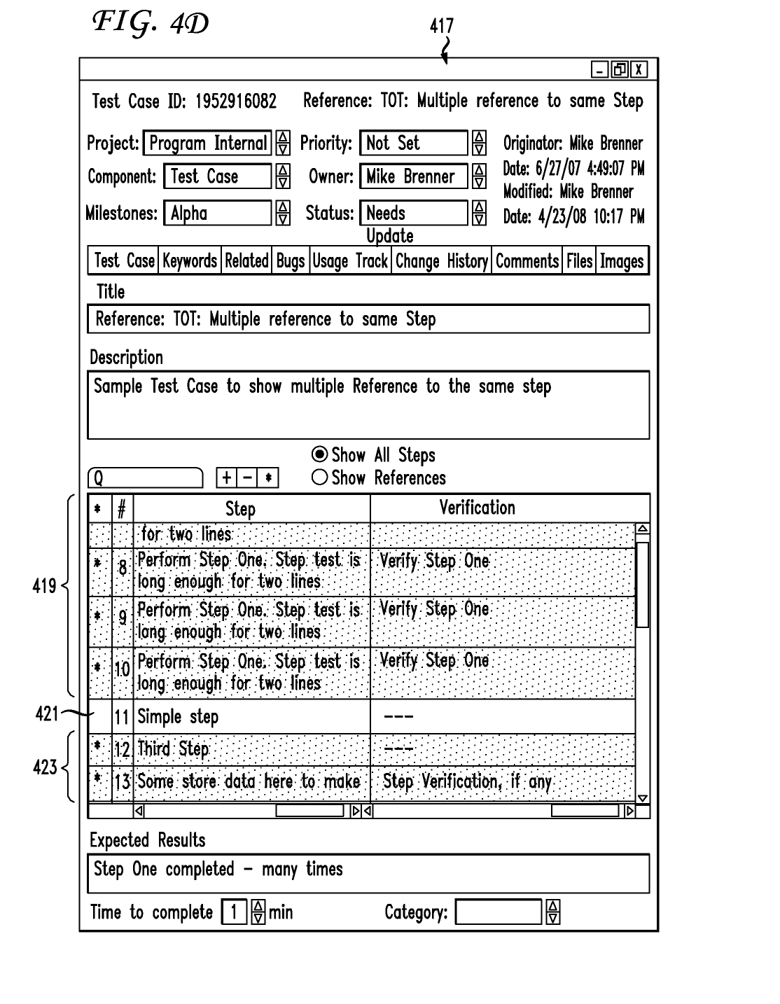

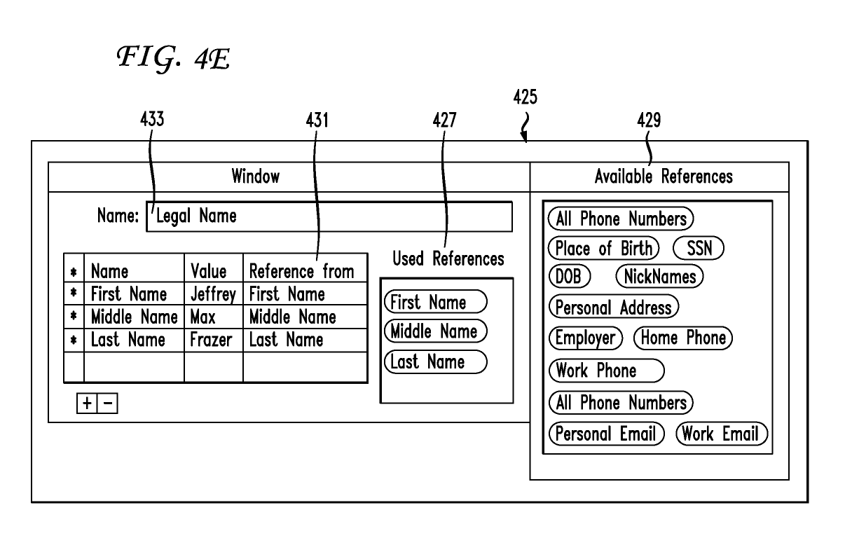

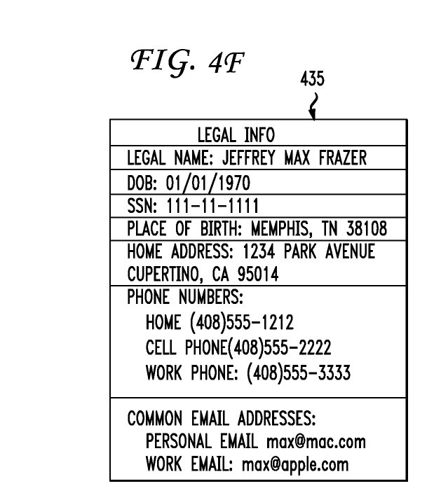

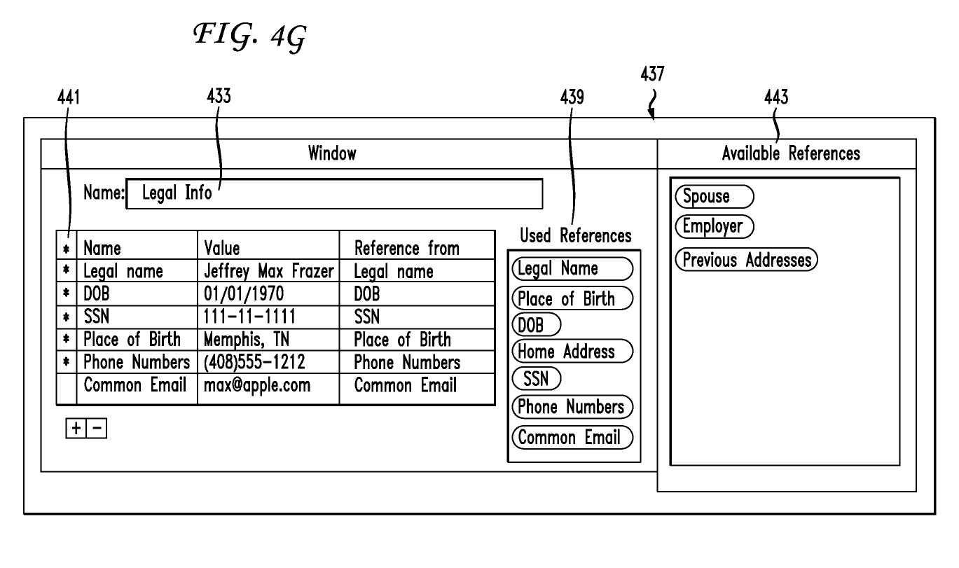

Each referenced object may contain multiple data types and values in an ordered set. These data types include (a) data native to the object and (b) references to one or more other objects. This includes pointers to data offered by external objects. As shown in FIG. 4A, a test case contains both native steps 403 and referenced steps 401. FIG. 4A is a representative screenshot 405 of a sample user interface.

As shown in screenshot 411 FIG. 4B, a test case contains both native steps 409 and a referenced step 407. The referenced step is highlighted and marked by an asterisk. In this example embodiment, the referenced step 407 may be opened and analyzed by double-clicking on the highlighted region. The referenced data may be, for example, an image, a file, or a comment. FIG. 4B is a representative screenshot 411 of this stage in a sample user interface.

FIG. 4C illustrates a screenshot 413 after double clicking and opening the highlighted referenced step 407 from FIG. 4B. In this example embodiment, the referenced step 415 includes the test step of “Click the Sign In button in the Sign in window”. FIG. 4C is a representative screenshot 413 of this stage in a sample user interface. In this example, the referenced object can be edited after clicking and opening the reference. Additionally, only users with proper privileges are allowed to modify referenced objects. Furthermore, if the original referenced object contains multiple values, the double-clicked value in the referencing object will open up that specific value in the original referenced object. Referencing supports ease of data maintenance and reusability. Changes to referenced objects, at any level deep, may automatically be inherited up the hierarchy to the higher referencing objects. Changes to referencing objects include (1) editing of data (native data), (2) addition of data (native and referenced), (3) removal of data (native and referenced), and (4) reordering of data (native and referenced).

Since an object may contain references to multiple other objects, referenced data, including an object, may be rearranged relative to other referenced data inside the object as well as any native data inside the object. Furthermore, each individual reference inside an object is treated as a single entity, even if the reference contains an ordered set of data. As such, single references may not be split, and their internal data may not be reordered at this level.

FIG. 4D illustrates a screenshot 417 of a test case contain two referencing objects 419, 423 with a native step 421 wedged in between. Each referencing object 419, 423 contains multiple steps in this example. Each referenced data object 419, 423 is visually differentiated from native data, and for user interaction are treated as unmodifiable data in the referencing object. In this context, the unmodifiable data is said to be “locked” and the order or sequence of steps of a referenced object cannot be modified. A user or the system cannot break the order or separate the distinct data elements from an individual referenced reference. Therefore, the order of steps within referenced object 419 and referenced object 423 are not modifiable at this level. FIG. 4D is a representative screenshot 417 of this stage in a sample user interface.

FIG. 4E illustrates a referencing object constructed from other referenced objects. The referenced object Legal Name 433 references referenced objects 431 Legal Name, DOB (Date of Birth), SSN (Social Security Number), Place of Birth, Phone Number and Common Email. These referenced objects are also displayed in the Used References display 427. Additionally, the screen shot displays all available references 429. FIG. 4E is a representative screenshot 425 of this stage in a sample user interface.

FIG. 4F illustrates another example of a referencing object constructed from other referenced objects. The object Legal Info 435 references referenced objects First Name, Middle Name, and Last Name. FIG. 4G is a representative screenshot 437 for manipulating the object Legal Info 435. A field 433 shows the name of the object being processed. These referenced objects are displayed in the Used References display 439. A section 441 shows the data associated with each referenced object and where it was referenced from. Additionally, the screenshot 437 displays all available references 443, which in this example includes data reference objects for spouse, children, employer and previous addresses. The circle around each of these objects in screenshot 437 indicates it is an available reference as a usable object.

In one aspect, all or part of the native and referenced steps depicted in FIGS. 4A-4G are represented in an outline view, in a graphical, hierarchical view, etc. An outline view can be a text display with indicators for references and indenting or some other convention demonstrating how references are used and what they point to. A graphical, hierarchical view can be a graphical display of how the data is organized, where references point, etc. One example of a graphical, hierarchical view is FIG. 2. Graphical, hierarchical views may be used as a user interface where a user can drag and drop to relocate references, left click to indicate where a reference points, right click to bring up menu options, option click to highlight, etc. Because using references reduces duplication, a vast quantity of information can be represented in a graphical or textual interface.

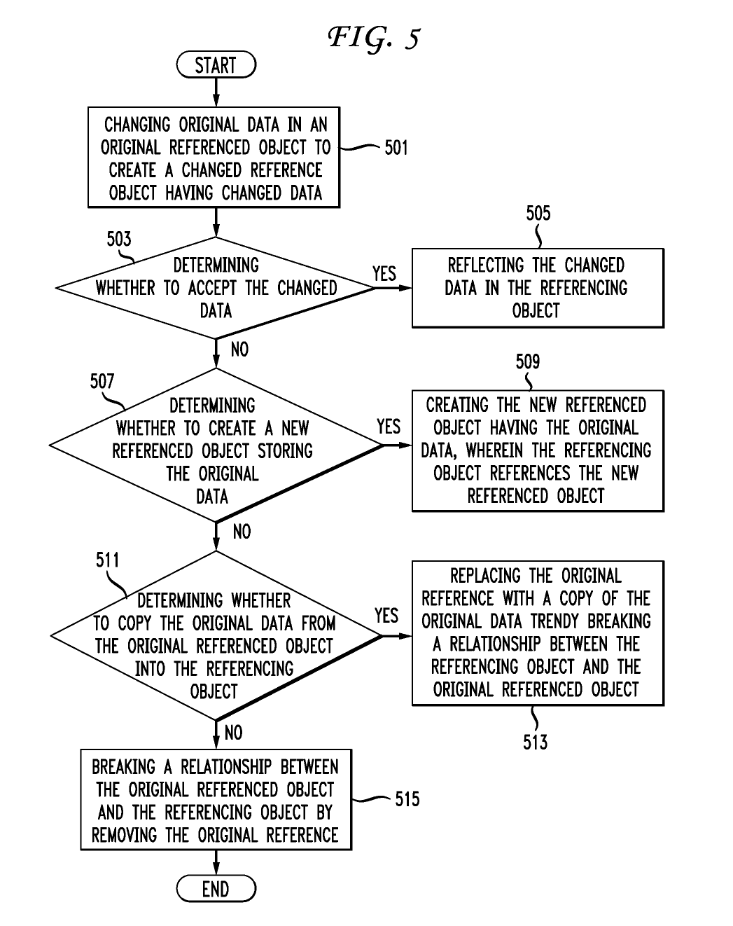

As shown in FIG. 5, the method includes changing original data in an original referenced object to create a changed referenced object having changed data 501. Next, the method includes determining whether to accept the changed data 503, and if the changed data is accepted, reflecting the changed data in the referencing object 505.

If the referencing object does not accept the changed data, the method includes determining whether to create a new referenced object storing the original data 507. If yes, the method includes creating the new referenced object having the original data, wherein the referencing object references the new referenced object 509. If no, the method includes determining whether to copy the original data from the original referenced object into the referencing object 511. If yes, the method includes replacing the original reference with a copy of the original data, thereby breaking a relationship between the referencing object and the original referenced object 513. If no, the method includes breaking a relationship between the original referenced object and the referencing object 515 by removing the original reference.

In one embodiment of FIG. 5, steps 503, 507, and 511 are each processed for each object of a plurality of referencing objects. In another embodiment of FIG. 5, steps 503, 507, and 511 are user initiated. In yet another embodiment, steps 503, 507, and 511 are managed by metadata associated with the referencing object. Additionally, in an example embodiment of FIG. 5, the metadata triggers a notification to a user to decide whether to accept changes based on the changed original data. Notification can be sent to a user via email, updating a website, an on-screen pop-up, a text message, an audible chime, or any combination. Notification can be sent to more than one user, for example, a notification can be sent to a software quality assurance manager and to a software tester who directly manipulates the software testing database. One way to transmit notifications is to send an email informing the user that a change has been made automatically, what the change is, and providing a link to a webpage to review or alter what was done automatically if the user decides that the automatic operation was improper. Notifications may occur with some frequency, so notification may be triggered in the form of a periodic report depicting multiple changes over a period of time which can be accepted or rejected as a group or individually.

Additionally, a plurality of referencing objects may exist in the structure and steps 503, 507, and 511 are carried out for each referencing object. In yet another embodiment a group of objects of the plurality of objects are assigned a set of propagation rules associated with how to manage the change in the original data. The propagation rules can be implemented in software, hardware, or in any manner known for setting propagation rules to a person of ordinary skill in the art.

Another embodiment of the system and method for data management may incorporate the use of variables within test cases. In this embodiment, test cases may be (1) steps or (2) an entire referenced test case. Users will be able to specify certain criteria for the referenced variables within, such as that a test case should be executed either a certain percentage of the time, or randomly when run in a test case assignment.

The system and method may use automatic creation of referenced test cases from two or more selections. Here, a user could specify placement of each set of references within the newly constructed test case. Also, automation scripts may be utilized in connection with the variables. Conditional logic structures may also be utilized. For example “If . . . Then” statements or looping tests can be used in a chosen programming language. Also, the system and method may track changes and give notification of changes. In one embodiment a user selects zero, one, or more of the following from which to track changes made to the original references: (a) steps, (b) comments, (c) file attachments, (d) images, and (e) scripts.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (by hardwired links, wireless links, or a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. A method of data management in which a structure is organized with a referencing object that may reference a referenced object comprising simple data elements, the method comprising:
(a) changing original data in an original referenced object to create a changed referenced object having changed data;
(b) in response to the changing, performing the following for a referencing object that references the original referenced object:
(i) determining whether to accept the changed data, and if the changed data is accepted, reflecting the changed data in the referencing object;
(ii) if the referencing object does not accept the changed data, determining whether to create a new referenced object storing the original data, and if yes:
(1) creating the new referenced object having the original data, wherein the referencing object references the new referenced object,
(iii) and if no:
(1) determining whether to copy the original data from the original referenced object into the referencing object, and if yes:
(a) replacing the original reference with a copy of the original data, thereby breaking a relationship between the referencing object and the original referenced object, and if no:
(b) breaking a relationship between the original referenced object and the referencing object by removing the original reference.

2. The method of claim 1, wherein steps (b)(i)-(b)(iii) each are processed for each object of a plurality of referencing objects.

3. The method of claim 1, wherein steps (b)(i)-(b)(iii) are user initiated.

4. The method of claim 1, wherein steps (b)(i)-(b)(iii) are managed by metadata associated with the referencing object.

5. The method of claim 4, wherein the metadata triggers a notification to a user to decide whether to accept changes based on the changed original data.

6. The method of claim 1, wherein a plurality of referencing objects exist in the structure and steps (b)(i)-(b)(iii) are carried out for each referencing object.

7. The method of claim 6, wherein a group of objects of the plurality of objects are assigned a set of propagation rules associated with how to manage the change in the original data.

8. A system for data management in which a structure is organized with a referencing object that may reference a referenced object comprising simple data elements, the system comprising:
(a) a module configured to change original data in an original referenced object to create a changed referenced object having changed data;
(b) in response to the changing, a module configured to perform the following for a referencing object that references the original referenced object:
(i) determining whether to accept the changed data, and if the changed data is accepted, reflecting the changed data in the referencing object;
(ii) if the referencing object does not accept the changed data, determining whether to create a new referenced object storing the original data, and if yes:
(1) creating the new referenced object having the original data, wherein the referencing object references the new referenced object,
(iii) and if no:
(1) determining whether to copy the original data from the original referenced object into the referencing object, and if yes:
(a) replacing the original reference with a copy of the original data, thereby breaking a relationship between the referencing object and the original referenced object, and if no:
(b) breaking a relationship between the original referenced object and the referencing object by removing the original reference.

9. The system of claim 8, wherein steps (b)(i)-(b)(iii) each are processed for each object of a plurality of referencing objects.

10. The system of claim 8, wherein steps (b)(i)-(b)(iii) are user initiated.

11. The system of claim 8, wherein steps (b)(i)-(b)(iii) are managed by metadata associated with the referencing object.

12. The system of claim 11, wherein the metadata triggers a notification to a user to decide whether to accept changes based on the changed original data.

13. The system of claim 8, wherein a plurality of referencing objects exist in the structure and steps (b)(i)-(b)(iii) are carried out for each referencing object.

14. The system of claim 13, wherein a group of objects of the plurality of objects are assigned a set of propagation rules associated with how to manage the change in the original data.

15. A computer-readable medium storing a computer program having instructions for data management in which a structure is organized with a referencing object that may reference a referenced object comprising simple data elements, the instructions comprising:
(a) changing original data in an original referenced object to create a changed referenced object having changed data;
(b) in response to the changing, performing the following for a referencing object that references the original referenced object:
(i) determining whether to accept the changed data, and if the changed data is accepted, reflecting the changed data in the referencing object;
(ii) if the referencing object does not accept the changed data, determining whether to create a new referenced object storing the original data, and if yes:
(1) creating the new referenced object having the original data, wherein the referencing object references the new referenced object,
(iii) and if no:
(1) determining whether to copy the original data from the original referenced object into the referencing object, and if yes:
(a) replacing the original reference with a copy of the original data, thereby breaking a relationship between the referencing object and the original referenced object, and if no:
(b) breaking a relationship between the original referenced object and the referencing object by removing the original reference.

16. The computer-readable medium of claim 15, wherein steps (b)(i)-(b)(iii) each are processed for each object of a plurality of referencing objects.

17. The computer-readable medium of claim 15, wherein steps (b)(i)-(b)(iii) are user initiated.

18. The computer-readable medium of claim 15, wherein steps (b)(i)-(b)(iii) are managed by metadata associated with the referencing object.

19. The computer-readable medium of claim 18, wherein the metadata triggers a notification to a user to decide whether to accept changes based on the changed original data.

20. The computer-readable medium of claim 15, wherein a plurality of referencing objects exist in the structure and steps (b)(i)-(b)(iii) are carried out for each referencing object.
